(19) United States
(12) Patent Application Publication
(10) Pub. No.: US 2014/0180891 A1
(43) Pub. Date: Jun. 26, 2014

(54) Systems and Methods to Offload Risk P&L Calculations

(71) Applicant: TRADING TECHNOLOGIES INTERNATIONAL, INC., Chicago, IL (US)

(72) Inventors: Andrew Theodore Renalds, Chicago, IL (US); Gregory John Ford, Chicago, IL (US)

(73) Assignee: TRADING TECHNOLOGIES INTERNATIONAL, INC., Chicago, IL (US)

(21) Appl. No.: 13/722,717

(22) Filed: Dec. 20, 2012

(51) Int. Cl. G06Q 40/04

(52) U.S. Cl. CPC G06Q 40/04
USPC 705/37

(57) ABSTRACT

Certain embodiments provide systems and methods to offload one or more components of risk checking for an order. An example method includes receiving, at a trading strategy engine, an order for a quantity of a tradeable object outbound to an exchange. The example method includes receiving, at the trading strategy engine, computed profit and loss data and margin data for a user associated with the order, the profit and loss data and margin data computed at a gateway external to the strategy engine. The example method includes evaluating whether the quantity associated with the order is greater than an order quantity limit. The example method includes computing a credit check with respect to the user and the order based on the profit and loss data and the margin data. The example method includes determining a risk associated with the order based on evaluating the quantity of the order and the credit check.

### CROSS-REFERENCE TO RELATED APPLICATIONS

U.S. Pat. Nos. 7,752,117, 7,587,356, 7,565,315, and 7,707,098 are commonly assigned to Trading Technologies, Inc., and are each incorporated by reference herein in their entirety.

### BACKGROUND

An electronic trading system generally includes a trading device in communication with an electronic exchange. The electronic exchange sends information about a market, such as prices and quantities, to the trading device. The trading device sends messages, such as messages related to orders, to the electronic exchange. The electronic exchange attempts to match quantity of an order with quantity of one or more contra-side orders.

Electronic exchanges have made it possible for an increasing number of participants to be active in a market at any given time. The increase in the number of potential market participants has led to, among other things, a more competitive market and greater liquidity. In the competitive environment of electronic trading, where every second or a fraction of second counts in intercepting trading opportunities, trading algorithms are beneficial to automate electronic trading.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 depicts an example trading system including a plurality of exchange hosts, a plurality of gateway servers, and a plurality of strategy engines.

FIG. 5 illustrates an example trading system including an algorithm strategy engine server connected to a gateway and one or more trading devices.

FIG. 6 illustrates an example trading system in which a strategy engine is in communication with a plurality of gateways to route order messages on behalf of a plurality of trading devices.

FIG. 7 shows a flow diagram of an example method to offload risk calculations in a trading system.

FIG. 8 shows a flow diagram of an example method to generate profit and loss and/or other information at a gateway to facilitate risk checking at a gateway in a trading system.

FIG. 9 shows a flow diagram of an example method to evaluate risk associated with a trading order by a strategy engine or trading device.

FIG. 10 illustrates a block diagram representative of an example risk calculator in a trading system.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

Exchanges facilitate transactions between users of a marketplace wanting to, for example, buy or sell one or more tradeable objects. An order submitted to an exchange is, for example, a buy order or a sell order for a given tradeable object. The exchange attempts to match received orders with contra-side orders available in a corresponding market. For example, to fulfill a received buy order for a tradeable object, the exchange analyzes availability of the first tradeable object on a market. Similarly, to fulfill a received sell order for the tradeable object, the exchange analyzes demand for the tradeable object on the market. The exchange can evaluate a level of risk or risk tolerance associated with the order and/or the trader placing the order, for example. The exchange then processes the order in accordance with the current conditions of the market. To process the trade orders, the exchange executes and/or facilitates a plurality of calculations, transactions, and communications, each of which consumes an amount of time. The amount of time taken by the exchange to fulfill an order is referred to herein as latency. As described in detail below, the latency of an exchange may be measured in a plurality of different manners and/or using a plurality of different benchmarks, triggers, factors, etc.

In many instances, terms of the transactions facilitated by the exchange are time-sensitive. Accordingly, users of the exchange desire low latency from the exchange. The matching engines and/or other components utilized by the exchange to process orders may become bogged down due to, for example, server related issues, network connectivity issues, swells in trading activity, computationally expensive tasks such as implied pricing calculations, etc. In other words, one or more factors may cause an increase in time taken to process an order at an exchange. In many instances, the outcomes of a trade are significantly affected by small amounts of time. Thus, users are highly interested in having trades processed by exchanges as quickly as possible.

Embodiments disclosed herein recognize that risk checking of an order should occur without appreciable increase in delivery latency that may adversely impact a trade order. Unlike prior trading systems and external translators, embodiments disclosed herein accommodate a plurality of trading devices and/or servers seeking to conduct risk checking while reducing or minimizing an impact of risk evaluation on communication latency, available processing power, etc. Embodiments disclosed herein facilitate offloading of profit and loss calculations for risk management in a trading system.

Although the description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. BRIEF DESCRIPTION OF CERTAIN EMBODIMENTS

Certain embodiments provide a method including receiving, at a trading strategy engine, an order for a quantity of a tradeable object outbound to an exchange. The example method includes receiving, at the trading strategy engine, computed profit and loss data and margin data for a user associated with the order, the profit and loss data and margin data computed at a gateway external to the trading strategy engine. The example method includes evaluating, at the trading strategy engine, whether the quantity associated with the order is greater than an order quantity limit. The example method includes computing a credit check at the trading strategy engine with respect to the user and the order based on the profit and loss data and the margin data. The example method includes determining, at the trading strategy engine, a risk associated with the order based on evaluating the quantity of the order and the credit check. The example method includes facilitating routing of the order to the exchange based on the risk.

Certain embodiments provide a system including a computing device configured to receive an order for a quantity of a tradeable object outbound to an exchange and to receive computed profit and loss data and margin data for a user associated with the order. In the example system, the profit and loss data and margin data are to be computed external to the computing device. The example computing device is configured to evaluate whether the quantity associated with the order is greater than an order quantity limit and compute a credit check with respect to the user and the order based on the profit and loss data and the margin data. The example computing device is to determine a risk associated with the order based on evaluating the quantity of the order and the credit check, wherein the computing device is to facilitate routing of the order to the exchange based on the risk.

Certain embodiments provide a tangible computer-readable storage medium comprising instructions that, when executed, cause a computing device to at least receive an order for a quantity of a tradeable object outbound to an exchange. The example instructions cause the computing device to at least receive computed profit and loss data and margin data for a user associated with the order, the profit and loss data and margin data computed external to the computing device. The example instructions cause the computing device to at least evaluate whether the quantity associated with the order is greater than an order quantity limit. The example instructions cause the computing device to at least compute a credit check with respect to the user and the order based on the profit and loss data and the margin data. The example instructions cause the computing device to at least determine a risk associated with the order based on evaluating the quantity of the order and the credit check. The example instructions cause the computing device to at least facilitate routing of the order to the exchange based on the risk.

### II. EXAMPLE ELECTRONIC TRADING SYSTEM

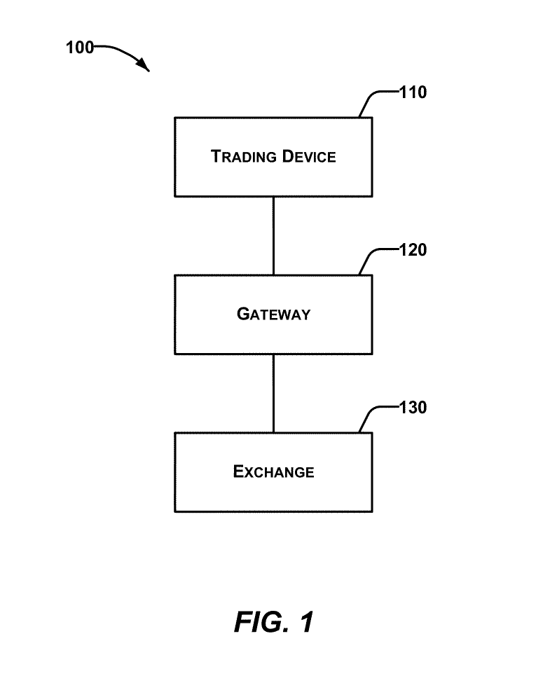

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market is the lowest available ask price (best offer) and the highest available bid price (best bid) in the market for a particular tradable object at a particular point in time (since the inside market may vary over time). Market depth refers to quantities available at the inside market and at other prices away from the inside market. There may not be quantities at all tradeable price levels. As such, there may be “gaps” in market depth.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange (for example, the exchange 130), a product defined by the user, a combination of real or synthetic products, or a combination thereof. There may be a synthetic tradeable object that corresponds and/or is similar to a real tradeable object.

An order message is a message that includes, for example, a command to place an order to buy or sell a tradeable object, a command to initiate managing orders according to a defined trading strategy, a command to change or cancel a previously submitted order (for example, modify a working order), an instruction to an electronic exchange relating to an order, or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL™, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may include computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a T1 line, a T3 line, an integrated services digital network (“ISDN”) line, a point-of-presence, the Internet, and/or a shared memory system, for example.

The gateway 120 may include one or more electronic computing platforms. For example, the gateway 120 may implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a virtual private network, a T1 line, a T3 line, an ISDN line, a point-of-presence, the Internet, and/or a shared memory system, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. EXPANDED EXAMPLE ELECTRONIC TRADING SYSTEM

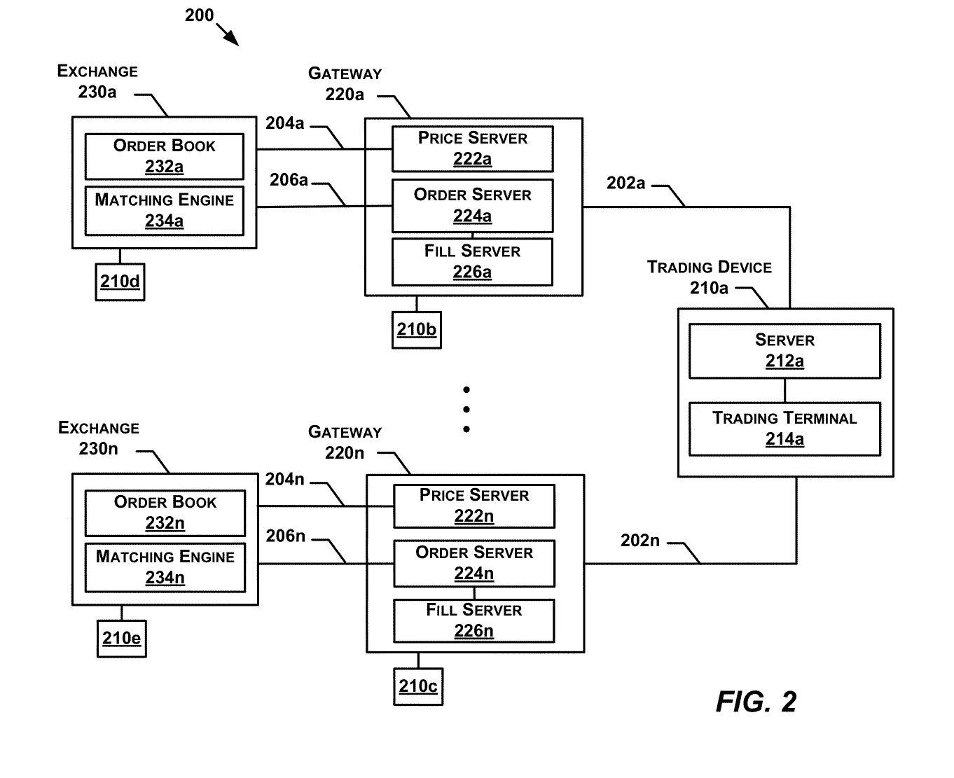

FIG. 2 illustrates a block diagram of another example electronic trading system 200 in which certain embodiments may be employed. In this example, a trading device 210a is in communication with an exchange 230a through a gateway 220a. The following discussion mainly focuses on the trading device 210a, gateway 220a, and the exchange 230a. However, the trading device 210a may also be connected to and communicate with any number of gateways 220n connected to exchanges 230n. The communication between the trading device 110a and other exchanges 230n may be the same, similar, or different than the communication between the trading device 210a and exchange 230a. Generally, each exchange has its own preferred techniques and/or formats for communicating with a trading device, a gateway, the user, or another exchange.

The trading device 210a, which may be similar to the trading device 110 in FIG. 1, may include a server 212a in communication with a trading terminal 214a. The server 212a may be located geographically closer to the gateway 220a than the trading terminal 214a. As a result, the server 212a latency benefits that are not afforded to the trading terminal 214a. In operation, the trading terminal 214a may provide a trading screen to a user and communicate commands to the server 212a for further processing. For example, a trading algorithm may be deployed to the server 212a for execution based on market data. The server 212a may execute the trading algorithm without further input from the user. In another example, the server 212a may include a trading application providing automated trading tools and communicate back to the trading terminal 214a. The trading device 210a may include, additional, different, or fewer components.

The trading device 210a may communicate with the gateway 220a using one or more communication networks. As used herein, a communication network is any network, including the Internet, which facilitates or enables communication between, for example, the trading device 210a, the gateway 220a and the exchange 220a. For example, as shown in FIG. 2, the trading device 210a may communicate with the gateway 220a across a multicast communication network 202a. The data on the network 202a may be logically separated by subject (for example, prices, orders, or fills). As a result, the server 212a and trading terminal 214a can subscribe to and receive data (for example, data relating to prices, orders, or fills) depending on their individual needs.

The gateway 220a, which may be similar to the gateway 120 of FIG. 1, may include a price server 222a, order server 224a, and fill server 226a. The gateway 220a may include additional, different, or fewer components. The price server 222a may process price data. Price data includes data related to a market for one or more tradeable objects. The order server 224a may process order data. Order data is data related to a user's trade orders. For example, order data may include order messages, confirmation messages, or other types of messages. The fill server collects and provides fill data. Fill data includes data relating to one or more fills of trade orders. For example, the fill server 226a may provide a record of trade orders, which have been routed through the order server 224a, that have and have not been filled. The servers 222a, 224a, 226a may run on the same machine or separate machines.

The gateway 220a may communicate with the exchange 230a using one or more communication networks. For example, as shown in FIG. 2, there may be two communication networks connecting the gateway 220a and the exchange 230a. The network 204a may be used to communicate market data to the price server 222a. In some instances, the exchange 230a may include this data in a data feed that is published to subscribing devices. The network 206a may be used to communicate order data.

The exchange 230a, which may be similar to the exchange 130 of FIG. 1, may include an order book 232a and a matching engine 234a. The exchange 230a may include additional, different, or fewer components. The order book 232a is a database that includes data relating to unmatched quantity of trade orders. For example, an order book may include data relating to a market for a tradeable object, such as the inside market, market depth at various price levels, the last traded price, and the last traded quantity. The matching engine 234a may match contra-side bids and offers. For example, the matching engine 234a may execute one or more matching algorithms that match contra-side bids and offers. A sell order is contra-side to a buy order with the same price. Similarly, a buy order is contra-side to a sell order with the same price.

In operation, the exchange 230a may provide price data from the order book 232a to the price server 222a and order data and/or fill data from the matching engine 234a to the order server 224a. Servers 222a, 224a, 226a may translate and communicate this data back to the trading device 210a. The trading device 210a, for example, using a trading application, may process this data. For example, the data may be displayed to a user. In another example, the data may be utilized in a trading algorithm to determine whether a trade order should be submitted to the exchange 230a. The trading device 210a may prepare and send an order message to the exchange 230a.

In certain embodiments, the gateway 220a is part of the trading device 210a. For example, the components of the gateway 220a may be part of the same computing platform as the trading device 210a. As another example, the functionality of the gateway 220a may be performed by components of the trading device 210a. In certain embodiments, the gateway 220a is not present. Such an arrangement may occur when the trading device 210a does not need to utilize the gateway 220a to communicate with the exchange 230a, for example. For example, if the trading device 210a has been adapted to communicate directly with the exchange 230a.

Additional trading devices 210b-210e, which are similar to trading device 210a, may be connected to one or more of the gateways 220a-220n and exchanges 230a-230n. Furthermore, additional gateways, similar to the gateway 220a, may be in communication with multiple exchanges, similar to the exchange 230a. Each gateway may be in communication with one or more different exchanges, for example. Such an arrangement may, for example, allow one or more trading devices 210a to trade at more than one exchange (and/or provide redundant connections to multiple exchanges).

### IV. EXAMPLE COMPUTING DEVICE

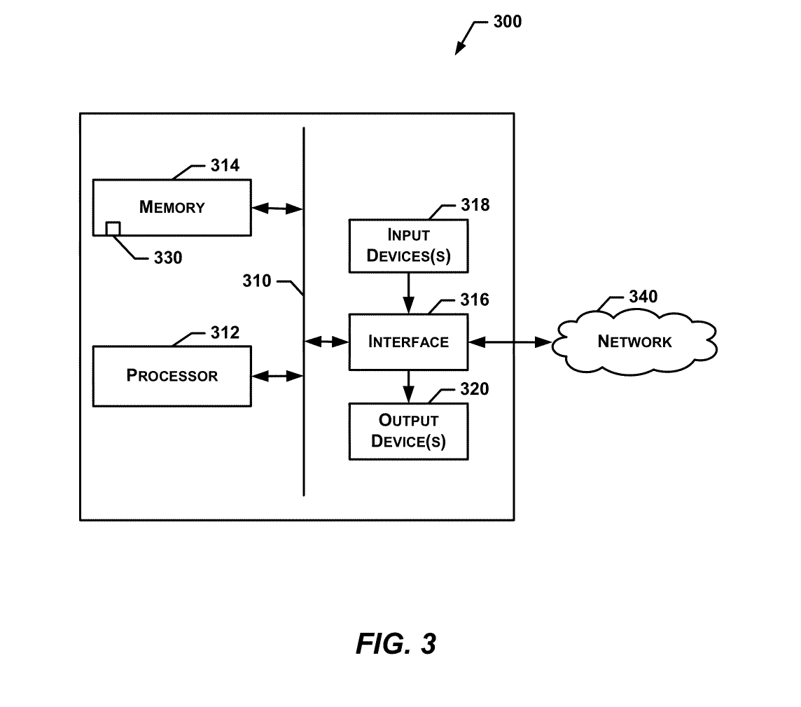

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. EXAMPLE P&L RISK CHECKING METHODS

Trade order and/or other messages can be transmitted between client devices (e.g., a trading device, an exchange, a gateway, etc.) according to a transmission protocol, such as the Financial Information eXchange (FIX) protocol. In certain examples, client applications and/or associated trading devices routing order messages perform risk checking Risk checking includes, but may not be limited to, a position check, an order quantity check, and a credit check, for example. A position check, for example, includes a comparison of a summation of order quantity, working quantities of existing orders and fills for a contract (e.g., Position=Order Qty+Working Quantities+Fills for Contract) to a user's position limit. To perform this position check calculation, information regarding orders and fills is used at the computing device.

A credit check includes a margin along with a realized and an unrealized profit and loss (P&L). In the futures market, for example, margin is the amount of money that is required to open a buy or sell position on a futures contract. The realized P&L is a gain or a loss resulting from opening and then closing a position in a tradeable object. The unrealized P&L refers to a profit or loss that has occurred “on paper” but has not yet been “realized” because a position in a tradeable object has not yet been closed with an offsetting transaction.

To perform the credit check calculation, orders and fills are used. The unrealized P&L component of the credit check also involves prices. However, processing price updates is expensive (e.g., in terms of processing time, system resources, delay, etc.). In certain examples, a client application subscribes to a price feed to perform the unrealized P&L portion of the credit check calculation. The price feed is computed and distributed by one or more devices (e.g., gateways) in a trading system, and one or more client applications can subscribe to the price feed, for example.

In certain examples, an adapter (e.g., a FIX adapter) enables one or more third party systems to connect to a trading platform using the industry-standard FIX messaging protocol. Using the adapter, order management systems (OMS), algorithmic futures traders, automated futures trading systems, black box trading systems, third-party front-ends, etc., can connect to a trading infrastructure for high-speed order routing, risk management, position monitoring, market data services, etc.

While the adapter may only be used to route orders, the adapter may still be subscribed to and have to process prices from one or more gateway price feeds in a trading infrastructure to perform the unrealized P&L part of the credit check. Some OMSs that connect to an adapter may route orders for thousands of different contracts, for example. Thus, the adapter is kept very busy processing price updates. Similarly, a trading application may be kept unnecessarily busy processing price updates if several brokers are sharing an order book and prices are not being utilized.

In certain examples, a server (e.g., a money server) is provided to offload or centralize P&L checking such that adapters and/or other client applications need not subscribe to price feeds. Additionally, client devices are freed up for other processing tasks aside from price update processing, etc. The server can be separate from or integrated with a gateway, for example.

In certain examples, rather than one or more client applications requesting P&L from the server, the money server broadcasts the result of P&L calculations at periodic intervals. In certain examples, if margin is not used in a credit check determination, the money server can broadcast a Boolean value instead of the result of a P&L calculation, the Boolean indicating whether or not a user/client application is over their/its limit. In certain examples, the money server can dynamically increase and/or decrease a risk associated with a user/client application. In certain examples, the money server can determine that a particular user/client application is not to be given a P&L risk check until it approaches an assigned limit. The limit can be set according to user/client application type, identification, market circumstances, etc. For additional information regarding trading limits, U.S. Pat. Nos. 7,752,117, 7,587,356, 7,565,315, and 7,707,098, commonly assigned to Trading Technologies, Inc., are each incorporated by reference herein in their entirety.

In certain examples, a strategy engine (e.g., an algorithmic strategy engine (ASE) such as ALGO SE™ provided by Trading Technologies, a synthetic strategy engine (SSE), etc.) is deployed in a trading network to facilitate generation and routing of orders to exchange(s). One or more strategy engines can be deployed in geographic proximity to the exchange(s) to which the engine(s) are to route trading orders. An algorithmic strategy engine can be used to facilitate graphical generation of a trading strategy resulting in one or more trading orders to be risk checked and routed, for example.

In certain examples, P&L risk checking can be enabled (e.g., by trading platform configuration, user profile, market condition, inside market, etc.). If P&L risk checking is enabled, the strategy engine is configured to connect to gateways (e.g., gateways 120, 220a-220n) to which any of its users (e.g., client applications, trading devices facilitating client application, etc.) are mapped. To perform a credit risk check, the strategy engine subscribes to messages (e.g., message feeds) for prices, orders, and fills relating to the gateway and its users. In certain situations, every order, fill, and price update is sent to a plurality of strategy engines by gateways located in different geographical regions. Upon receiving the updates, each of the strategy engines is performing the same calculation.

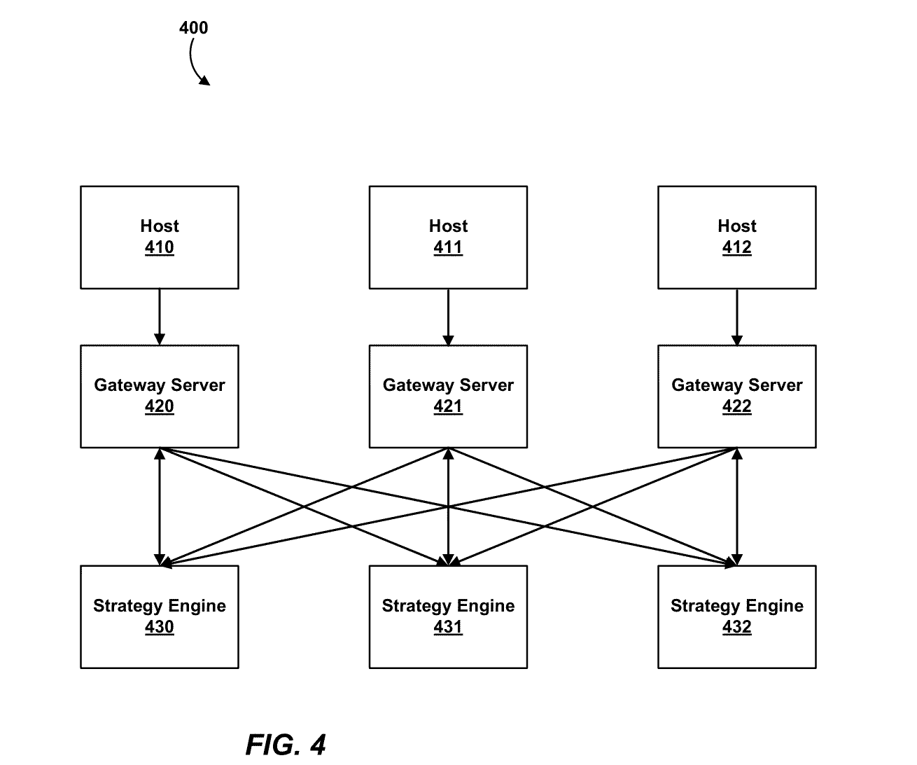

FIG. 4 depicts an example trading system 400 including a plurality of exchange hosts 410-412, a plurality of gateway servers 420-422, and a plurality of strategy engines 430-432. As shown in FIG. 4, each strategy engine 430-432 is receiving a message feed from each of the three gateway servers 420-422 and is processing price updates from each of the feeds. As a result, the strategy engines 430-432 can become burdened with additional processing, as well as an increase in network traffic resulting from the sending of duplicate messages. Trading can be affected as a result. While P&L risk checking can be turned off (e.g., if a system is concerned only with position checking), an elimination of risk checking is often not allowed and rarely desirable. Instead, certain examples facilitate offloading of price feed processing and P&L calculation to determine risk for multiple strategy engines and/or trading devices.

In certain examples, a strategy engine performs risk checking on behalf of users for whom the engine is to route orders. Risk checking includes an analysis of order quantity, position, and credit. Order quantity is a quantity or amount of an outbound order. A position is a representation of the summation of fills for a user on a destination gateway. Credit is determined based on margin and P&L. Margin relates to orders and fills on gateways to which a user is mapped. P&L relates to orders and fills on gateways to which a user is mapped as well as prices for contracts for which a non-zero position exists.

In certain examples, margin is calculated by summing a product of worst-case-position (WCP) and margin-required-per-contract (MRPC) over contracts for which a user has at least one order or fill (N). As a result:

Total Margin Used=Σᵢ₌₁^{N}WCPᵢ×MRPCᵢ (Eq. 1).

In certain examples, P&L is calculated by summing a realized P&L and an unrealized P&L over contracts for which a user has at least one fill (M). The P&L can be expanded for each contract as follows:

$$\begin{matrix}Total Sell Quantity ( TSQ ) = {\sum }_{i = 1}^{NSF} {FillQty}_{i} , & ( Eq . 2 ) \\ Total Buy Quantity ( TBQ ) = {\sum }_{i = 1}^{NBF} {FillQty}_{i} , & ( Eq . 3 ) \\ Average Sell Price ( ASP ) = \frac{{\sum }_{i = 1}^{NSF} {FillQty}_{i} \times {FillPrice}_{i}}{TSQ} , & ( Eq . 4 ) \\ Average Buy Price ( ABP ) = \frac{{\sum }_{i = 1}^{NBF} {FillQty}_{i} \times {FillPrice}_{i}}{TBQ} , & ( Eq . 5 )\end{matrix}$$

where NBF is a number of buy fills and NSF is a number of sell fills.

Based on the above equations 2-5, if NSF is greater than NBF, then an average open price (AOP) equals the average sell price (ASP). If NBF is greater than NSF, then an average open price (AOP) equals the average buy price. If NBF is equal to NSF, then the average open price (AOP) is not applicable.

Using these Equations 2-5, P&L can be defined as follows:

P&L=Σᵢ₌₁^{M}RealizedPLᵢ+UnrealizedPLᵢ=Σᵢ₌₁^{M}((ASPᵢ−ABPᵢ)×(MIN(TSQᵢ,TBQᵢ)))+((LTPᵢ−AOPᵢ)×(ABS(TSQᵢ−TBQᵢ))) (Eq. 6).

While a value other than LTP can be used as the theoretical exit price in the unrealized P&L calculation, LTP is used in Equation 6 for purposes of example illustration only.

Given the P&L (realized and unrealized) calculation in Equation 6 and the total margin used in Equation 1, a credit check can be performed. When combined with order quantity and position checking, a complete risk check can reveal an actual or potential risk for a user and/or trading strategy, for example.

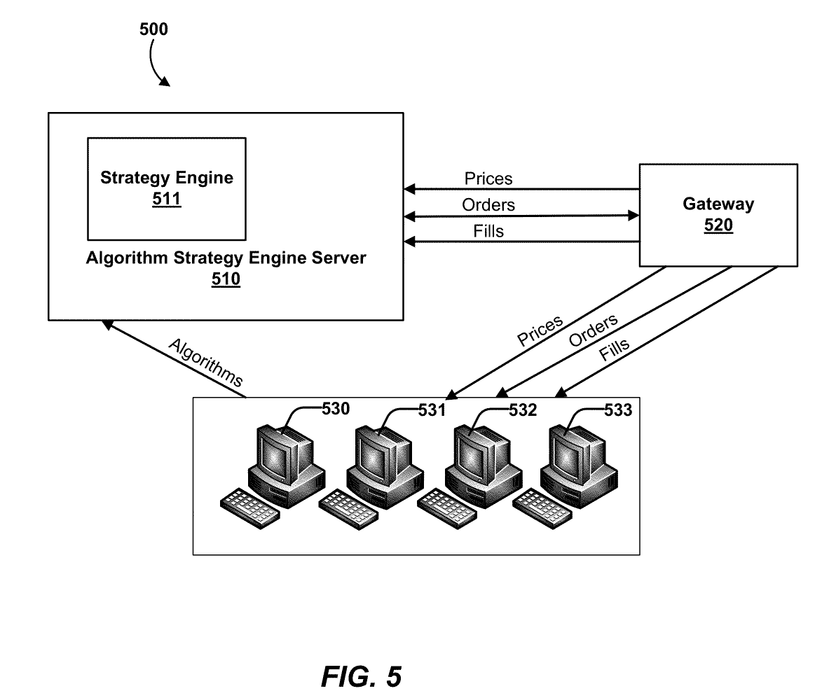

FIG. 5 illustrates an example trading system 500 including an algorithm strategy engine server 510 connected to a gateway 520 and one or more trading devices 530-533. The algorithm strategy engine server 510 includes a strategy engine 511, for example. The algorithm strategy engine server 510 and the gateway 520 are located in close proximity to an exchange matching engine, for example.

As shown in the example of FIG. 5, the strategy engine 511 generates trading strategies such as trading spreads. A spread and/or other trading strategy can be provided using a trading algorithm generator, such as Algo Design Lab (ADL™) provided by Trading Technologies, to facilitate generation, deployment and execution of custom trading algorithms. In certain examples, the strategy engine 511 accommodates an algorithm including contracts from a plurality of geographically separated markets, and a location of the strategy engine 511 is determined based on the algorithm.

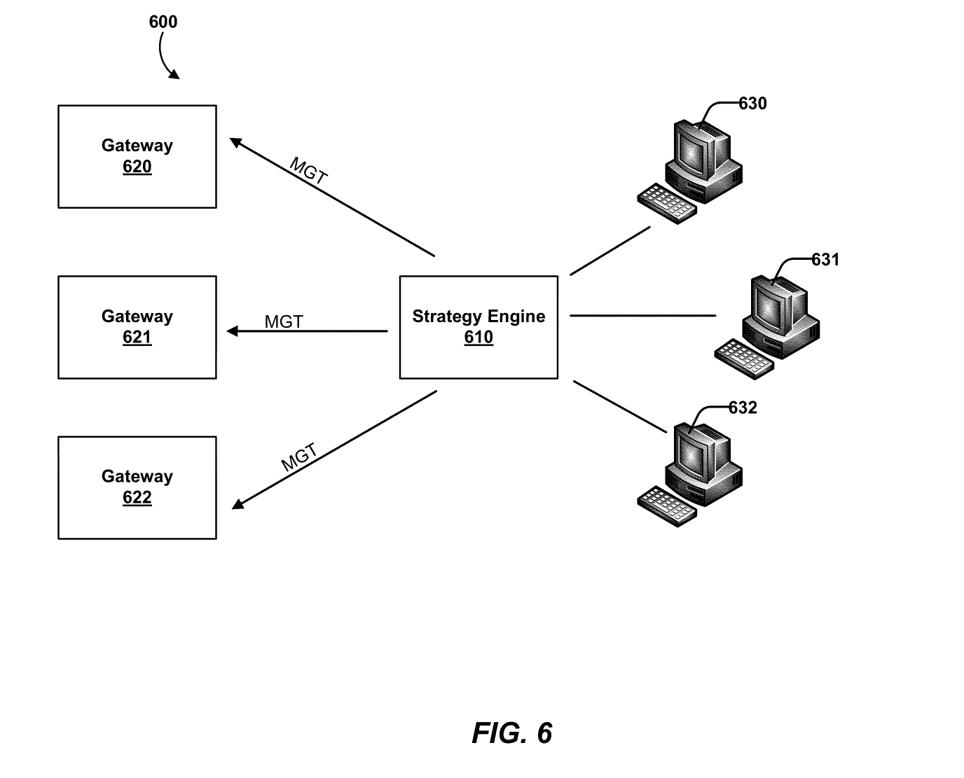

FIG. 6 illustrates an example trading system 600 in which a strategy engine 610 is in communication with a plurality of gateways 620-622 to route order messages on behalf of a plurality of trading devices 630-632. In certain examples, one or more of the gateways 620-622 include a price server. The gateway price servers disseminate (e.g., multicast) coalesced and/or non-coalesced prices. The strategy engine 610 provides one or more member, group, and trader identifiers (MGTs) to log in to a specified gateway 620-622. In this environment, gateways 620-622 support price, order, and fill servers, with the price server configured to disseminate non-coalesced and/or coalesced prices to a multicast group. The strategy engine 610 can share the multicast prices with one or more trading devices 630-632, for example.

In certain examples, the strategy engine 610 logs into each gateway 620-622 once and acts on behalf of trading devices 630-632 connected to each gateway 620-622. The strategy engine 610 uses MGTs with permissions to view orders and fills of connected trading devices 630-632. Determination of login credentials may vary depending on whether P&L risk checking is enabled, for example.

If P&L risk checking is activated, the strategy server 610 performs a complete risk check (e.g., on maximum order quantity or other order quantity limit, maximum position, and P&L) for orders that the server 610 routes on behalf of connected trading devices 630-632. In order to provide the risk check, connected trading devices 630-632 are to be mapped to the same or a subset of gateways 620-622 to which the strategy server 610 is configured to connect. Additionally, the MGTs to which the trading devices 630-632 are mapped are to be the same or hierarchically below the IDs the strategy engine 610 uses to log in to the gateways 620-622.

If P&L risk checking is not activated, the strategy server 610 performs a partial risk check (e.g., based on maximum order quantity/order quantity limit, and maximum position) for orders that the engine 610 routes on behalf of connected trading devices 630-632. Thus, the strategy engine 610 has a picture of a user's 630-632 risk for an order's target gateway 620-622. As a result, the MGT to which a trading device 630-632 is mapped for a particular gateway 620-622 is to be the same or hierarchically below the MGT that the strategy engine 610 uses to log into the particular gateway 620-622.

Certain examples optimize or otherwise improve risk calculations for a strategy engine (e.g., an Algo Strategy Engine or ALGO SE™ provided by Trading Technologies). An example strategy engine uses a visual algorithm assembly platform, such as ADL™, to develop and deploy simple to complex trading algorithms without complicated programming. For example, users with appropriate permissions can deploy algorithms to the strategy server of their choice in seconds, whether that server is across town or around the world. Traders can deploy algorithms strictly for their own use, or share them with one or more users without assistance from trading systems administrators or operations staff.

In certain examples, the strategy engine provides server-side execution for one or more of algorithmic, spread, and synthetic trading (e.g., a synthetic strategy engine or SSE). The strategy engine leverages proximity-based computing and a scalable multithreaded server design to deliver sub-millisecond performance with respect to a trading device and an exchange.

In certain examples, client applications (e.g., including strategy engines) can conduct risk calculation including a position check (e.g., market specific) and a P&L check (e.g., aggregate P&L checks across markets). However, client applications that cross markets have to connect to all applicable markets and receive information from each market in order to perform the P&L check. The client application subscribes to feeds and receives traffic from all relevant markets to perform the check(s) for risk calculation. Thus, each strategy engine and/or other client is duplicatively listening to market traffic.

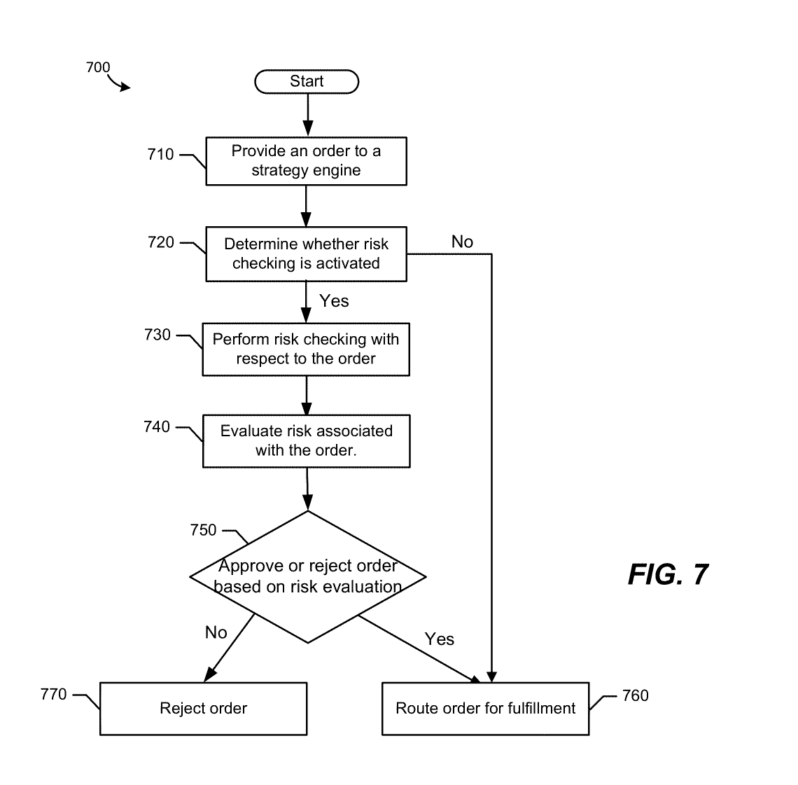

However, the gateways themselves have the data to conduct position and partial P&L checks and can provide calculations and data to multiple strategy engines and/or client trading devices, reducing occupied bandwidth, message latency, and processing time, for example. FIG. 7 shows a flow diagram of an example method 700 to offload risk calculations in a trading system. Using the example method 700, risk calculation is effectively moved to a gateway server, such as gateway 620-622. Information can be provided to a strategy engine or other trading device. For purposes of illustration, the examples below will be discussed in connection with a gateway and a strategy engine. At block 710, an order is provided from a trading device to a strategy engine. For example, a trading device provides a trading algorithm or strategy developed in conjunction with the strategy engine. At block 720, it is determined whether risk checking is activated. If not, at block 760, the order is routed to an exchange (e.g., via a gateway) for action (e.g., fulfillment).

If risk checking is activated, then, at block 730, the strategy engine performs risk checking to verify that the order is allowed to proceed. For example, the strategy engine evaluates an order quantity of the outbound order, a position of the user (e.g., outstanding orders and fills), and available credit for the user (e.g., orders and fills for the user, as well as fills and contract prices to determine a P&L for the user, etc.) to determine whether the proposed outbound order is within an acceptable risk tolerance for the user. For example, a risk tolerance can be based on trader experience level, current market conditions, outstanding orders and/or fills, trading algorithm complexity level. Risk checking can include user position risk checking, checking to avoid orders that will cross (e.g., a buy and a sell of the same tradeable object quantity, etc.), etc.

At block 730, the gateway server provides information to the strategy engine to conduct the risk checking calculation(s). The gateway may periodically push information to the strategy engine, and/or the strategy engine may request or pull information from the gateway in response to an order and/or other trigger, for example. The gateway provides one or more information feeds including order, fill, and/or price feed to the requesting strategy engine so that the strategy engine can perform the risk calculation.

The gateway can provide a subscription-based P&L feed based on a price feed, an order feed, and a fill feed maintained by the gateway. The P&L feed aggregates P&L over a particular group. In certain examples, rather than broadcasting each change in real time (or near real time), the gateway can broadcast an update after a certain time period (e.g., every n seconds), when P&L changes more than a certain threshold or percentage, etc. In certain examples, one or more filters can be set to allow setting of when/how often it should be broadcast. Multiple gateways, each connected to a different market, listens to that particular P&L feed to perform an aggregate P&L calculation, for example.

In certain examples, a local gateway performs a localized P&L calculation and can either send out the result after each calculation is performed or, upon comparison to a threshold or parameter, the gateway can send periodic updates. Localized P&L calculation information is sent to other clients and/or gateways to be combined with their local information, for example.

In certain examples, the gateway includes a central order book including order for trading devices accessing that gateway. Additionally, the gateway may be in close proximity to the exchange and is therefore able to react and respond more quickly than client trading devices.

Further, by calculating P&L at the gateway, traffic between gateways and clients (and associated strategy engines) can be reduced such that clients can avoid subscribing to receive as much data as they must in current data systems. Gateway calculation and providing of results to strategy engines, for example, can facilitate both risk checking and avoidance of orders that cross.

In certain examples, a gateway can adjust a priority of one or more threads handling P&L related calculations. For example, a gateway can offload a calculation to a lower priority thread given an amount of order traffic. Depending upon risk sensitivity, accuracy level, etc., the priority level can be adjusted (e.g., the more exact a risk calculation (and thus a P&L calculation) desired, the higher the priority should be). For example, adjusting a priority of a calculation thread makes the gateway faster or slower to provide periodic and/or real time (or near real time) monitoring and risk analysis.

In certain examples, a gateway can provide cumulative values by exchanging their local P&Ls without client involvement and aggregating local P&L calculations to provide a cumulative P&L calculation. By receiving an aggregate value from the gateway, a client need not receive live, constantly changing P&L feed responsive to every price change (e.g., often hundreds per second) but can rather save processing and bandwidth resources by receiving a period aggregate update.

In certain examples, the gateway can provide other risk calculation information in addition to or instead of P&L feed information. For example, a position check, crossing order evaluation, etc., can be provided to a client computing device (e.g., a strategy server).

At block 740, the strategy engine evaluates a risk associated with the order and the user. For example, based on the P&L feed and margin, a credit value is determined for the client. Additionally, a position for the client is determined based on orders and fills. Based on the determined position and credit, the outbound order can be evaluated to determine a risk for the user. For example, the computed values for credit, position, and outbound order can be compared to one or more risk tolerance criteria including trader experience level, current market conditions, trading algorithm complexity level, etc. A risk check can also include a check to determine that the user has not submitted an order that will cross itself (e.g., if the user issues a buy order at 100 and a sell order at 100, system rejects the orders for that particular market because the user has crossed itself).

At block 750, the strategy engine approves or rejects the order based on the risk check. At block 760, if the order is approved, the order is routed to the exchange for completion. If the order is not approved, then, at block 770, the order is not routed for fulfillment. A rejection, warning, or error message can be returned to the user, for example.

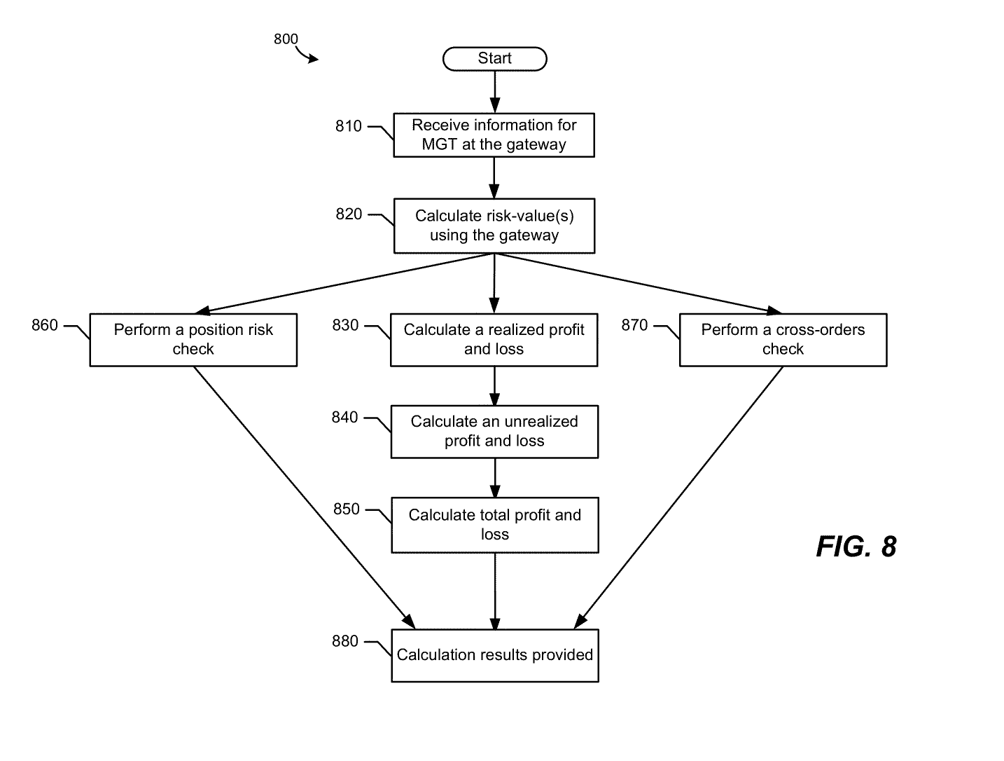

FIG. 8 shows a flow diagram of an example method 800 to generate P&L and/or other information at a gateway to facilitate risk checking in a trading system. The example method 800 represents further detail associated with block 730 of FIG. 7, for example. At block 810, the gateway receives order, fill and price information for one or more MGTs associated with (e.g., mapped to) the gateway. At block 820, one or more values are calculated by the gateway. The calculated risk-related values for an outbound order can be provided to a trading device, such as a strategy engine.

At block 830, a realized P&L is calculated. For example, the realized P&L is calculated by the gateway based on a fill quantity, a fill price, a total sell quantity, a total buy quantity, an average sell price, and an average buy price (e.g., Equations 2-6). At block 840, an unrealized P&L is calculated. For example, the unrealized P&L is calculated by the gateway based on a last traded price (or any other suitable theoretical exit price), an average open price, a total sell quantity, and a total buy quantity. At block 850, a total P&L is calculated based on the realized and unrealized P&L. For example, by combining the realized P&L and the unrealized P&L as in Equation 6, a total P&L can be calculated for an MGT via the gateway.

At block 860, the gateway performs a position risk check. The worst-case-position position calculation can be determined based on orders and fills for the given user via the gateway. The gateway compares the orders submitted and the fills received to determine the user's worst-case-position. The worst-case-position can be used to evaluate a user's risk associated with the new additional outgoing order.

At block 870, the gateway performs an avoid-orders-that-cross check. For example, the gateway reviews the outgoing order(s) to identify a buy order and a sell order from the same user for the same tradeable object. In some examples, crossing orders are prohibited, and the gateway can identify and flag such orders.

At block 880, calculation results are provided by the gateway. For example, the gateway can provide one or more of the realized P&L, unrealized P&L, total P&L, position check, crossing order identification, etc., via push and/or pull to one or more strategy engines, other trading devices, etc. The gateway can provide one or more subscription feeds sent periodically to one or more recipients, for example.

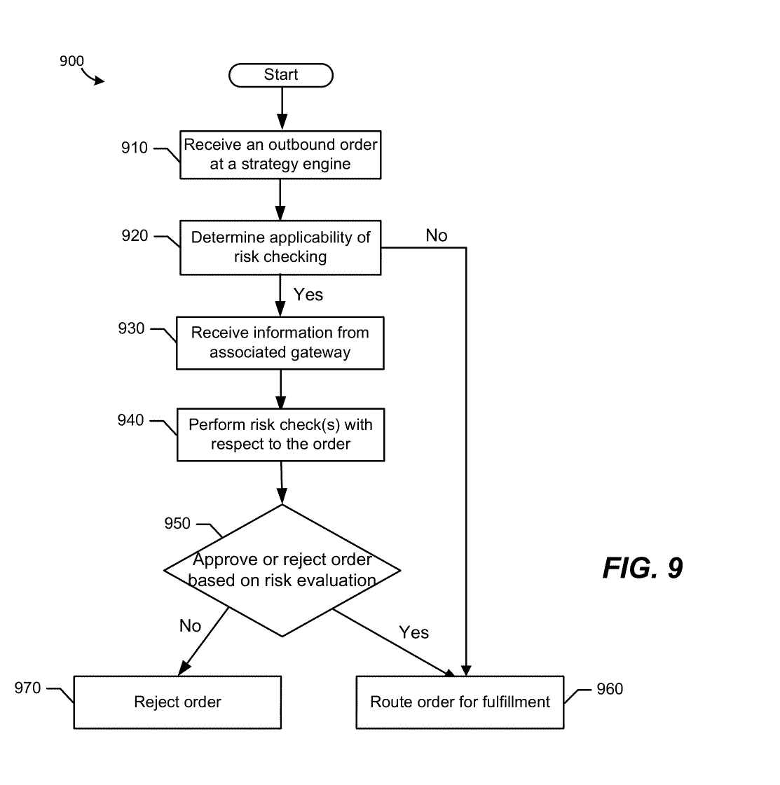

FIG. 9 shows a flow diagram of an example method 900 to evaluate risk associated with a trading order by a strategy engine or trading device. The example method 900 represents further detail associated with blocks 740-770 of FIG. 7, for example. At block 910, the strategy engine receives an outbound exchange order heading for an exchange. At block 920, an applicability of risk checking is determined. If risk checking is not activated or is not applicable, then, at block 960, the order is routed for execution (e.g., fulfillment).

If risk checking is applicable, then, at block 930, the strategy engine receives information from an associated gateway to perform the risk checking evaluation. For example, the strategy engine receives, via a push subscription and/or pull request for information from the gateway, order, credit (e.g., “credit used up” events, credit analysis/calculation, etc.), MRPC per user, and/or P&L information from the gateway. For example, the strategy engine subscribes to P&L feed, “credit used up” events, MRPC per user, etc., from an associated gateway. In certain examples, to reduce or minimize broadcast updates, information is sent every X seconds, changes by more than Y percent, etc.

At block 940, the strategy engine performs one or more risk checks with respect to the order based on information received from the gateway. For example, based on the P&L feed and margin, a credit value is determined for the client. Additionally, a worst-case-position for the client is determined based on orders and fills. Based on the determined worst-case-position and credit, the outbound order can be evaluated to determine a risk for the user. For example, the computed values for credit, worst-case-position, and outbound order quantity can be compared to one or more risk tolerance criteria including trader experience level, current market conditions, trading algorithm complexity level, etc. A risk check can also include a check to determine that the user has not submitted an order that will cross itself (e.g., if the user issues a buy order at 100 and a sell order at 100, system rejects the orders for that particular market because the user has crossed itself).

For example, the strategy engine receives a MRPC for each user as well to calculate margin. Position risk and/or avoid-orders-that-cross checks can be conducted by the gateway and results provided to the strategy engine, for example. Alternatively or in addition, a “credit used up” for an applicable MGT is used by the strategy engine in risk checking. The “credit used up” can be summed for each MGT to which a user is mapped.

Then, the strategy engine performs one or more risk checks when routing an order. For example, the strategy engine determines whether the current order quantity is less than or equal to a maximum order quantity or other order quantity limit provided for the user (e.g., the MGT):

Order Qty≦Max Order Quantity (Eq. 7).

Additionally, the strategy engine determines whether a total credit minus a total credit used up minus an order quantity by MRPC is greater than zero:

Total Credit−Total Credit Used Up−(Order Qty×MRPC)>0 (Eq. 8).

At block 950, the strategy engine approves or rejects the order based on the risk check(s). At block 960, if the order is approved, the order is routed to the exchange for completion. If the order is not approved, then, at block 970, the order is not routed for fulfillment. A rejection, warning, or error message can be returned to the user, for example.

### VI. EXAMPLE P&L RISK CHECKING PROCESSOR

As disclosed above, a gateway can offload and/or otherwise assist a strategy engine or trading device in evaluating a risk associated with an order for a user. For example, a “money” server can be configured with (e.g., as a part of, associated with, etc.) the gateway to conduct and/or help conduct one or more risk checks with and/or for a strategy engine, trading device, and/or other computing device. In certain examples, instead of or in addition to the gateway/money server, a centralized risk server can be fed relevant information feed(s) to provide one or more risk check results to provide risk evaluation (s) for a user/order.

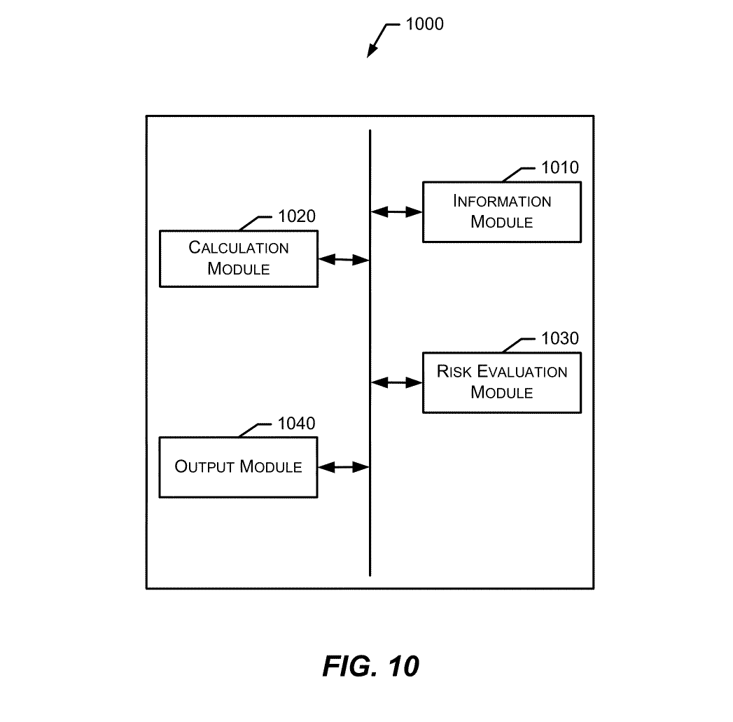

FIG. 10 illustrates a block diagram representative of an example P&L risk calculator 1000 in a trading system. The risk calculator 1000 can be implemented as part of or across one or more of a gateway, a strategy server, a trading device, and/or other computing device, for example. The example risk calculator 1000 includes an information module 1010, a calculation module 1020, a risk evaluation module 1030, and an output module 1040.

The information or information reception module 1010 receives information, such as order, fills, price, quantity, MRPC, etc. The information module 1010 can receive information from a gateway, order server, strategy engine, trading device, etc. The information module 1010 can receive information via a push and/or pull model continuously and/or periodically, for example. The information module 1010 provides information to the calculation module 1020.

The calculation module 1020 performs one or more calculations based on received information. For example, P&L, position, crossing-orders, credit, margin, etc., can be determined based on available information via the calculation module 1020. For example, the calculation module 1020 can utilize one or more of Equations 1-8 to generate one or more values that can be used in a risk checking evaluation with respect to an order and/or a user.

The risk evaluation module 1030 takes the one or more values generated by the calculation module 1020 and evaluates a risk associated with an order and/or user based on the calculated value(s). For example, a user's credit risk can be determined based on a comparison of margin and P&L. A user's position can be evaluated based on a received order quantity and working quantities of existing orders and fills for a contract. Credit, position, and/or other risk computation can be compared to one or more applicable limits and/or thresholds (e.g., a position limit, a credit limit, etc.) to evaluate risk. As outlined in Equations 7 and 8, position and/or available credit can be evaluated to determine a risk associated with the pending order and/or user associated with the order. The output module 1040 can provide a result of the risk evaluation. For example, the output module 1040 can provide a yes or no with respect to the pending outgoing order, calculate value(s) associated with the risk check(s), etc.

The risk calculator 1000 can be implemented as one or more computing devices configured to calculate one or more values related to risk checking based on available information and evaluate a risk associated with an order (and/or a user associated with the user). For example, the risk calculator 1000 can be implemented at a gateway and used to provide some or all risk evaluation information to a strategy engine. Alternatively or in addition, the risk calculator 1000 can be implemented at the strategy engine and can evaluate risk based on information received from the gateway. In certain examples, the risk calculator 1000 can be implemented as a separate server (e.g., a money server) associated with the gateway, strategy server, and/or trading device.

Thus, certain embodiments provide improved risk checking in an electronic trading system. Certain embodiments help reduce processing time, message traffic, and latency involved in risk checking calculation and evaluation. Certain embodiments help to concentrate or centralize some or all risk checking calculations at a point, such as a gateway or dedicated server, where most or all information involved is already received.

For example, a gateway provides one or more of an order feed, a price feed, a fill feed, and a P&L feed (e.g., “live” or periodic based on timing and/or change in value) to a strategy engine which can evaluate a risk associated with an order by shouldering a reduced processing and latency burden.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method comprising:
receiving, at a trading strategy engine, an order for a quantity of a tradeable object outbound to an exchange;
receiving, at the trading strategy engine, computed profit and loss data and margin data for a user associated with the order, the profit and loss data and margin data computed by a gateway external to the trading strategy engine;
evaluating, at the trading strategy engine, whether the quantity associated with the order is greater than an order quantity limit;
computing a credit check at the trading strategy engine with respect to the user and the order based on the profit and loss data and the margin data;
determining, at the trading strategy engine, a risk associated with the order based on evaluating the quantity of the order and the credit check; and
facilitating routing of the order to the exchange based on the risk.

2. The method of claim 1, wherein facilitating routing further comprises approving the routing of the order to the exchange based on a positive outcome of the risk determination and rejecting the order based on a negative outcome of the risk determination.

3. The method of claim 1, further comprising evaluating a worst-case-position of the user based on past orders and fills.

4. The method of claim 1, wherein the margin data is computed by summing a product of worst case position and margin required per contract for the user.

5. The method of claim 4, wherein computing the credit check further comprises computing a credit result for the user based on a total credit for the user minus a total credit used up for the user minus a product of the order quantity and the margin required per contract (Total Credit−Total Credit Used Up−(Order Quantity×MRPC)) and determining whether the credit result is greater than zero.

6. The method of claim 1, wherein the profit and loss data and the margin data are computed by and received from the gateway when at least one of the profit and loss data and the margin data changes by a defined amount.

7. The method of claim 1, further comprising computing, at the gateway, at least one of a crossing order check and a position risk check for the order and the user.

8. The method of claim 1, wherein the computed profit and loss data is computed by summing realized profit and loss and unrealized profit and loss over contracts for which the user has at least one fill.

9. A system comprising:
a computing device configured to receive an order for a quantity of a tradeable object outbound to an exchange and to receive computed profit and loss data and margin data for a user associated with the order, the profit and loss data and margin data to be computed external to the computing device, the computing device configured to evaluate whether the quantity associated with the order is greater than an order quantity limit and compute a credit check with respect to the user and the order based on the profit and loss data and the margin data, the computing device to determine a risk associated with the order based on evaluating the quantity of the order and the credit check, wherein the computing device is to facilitate routing of the order to the exchange based on the risk.

10. The system of claim 9, wherein the computing device is to facilitate routing by approving the routing of the order to the exchange based on a positive outcome of the risk determination or rejecting the order based on a negative outcome of the risk determination.

11. The system of claim 9, wherein the computing device is to evaluate a position of the user based on past orders and fills.

12. The system of claim 9, wherein the margin data is computed by summing a product of worst case position and margin required per contract for the user.

13. The system of claim 12, wherein the computing device is to compute the credit check by computing a credit result for the user based on a total credit for the user minus a total credit used up for the user minus a product of the order quantity and the margin required per contract (Total Credit−Total Credit Used Up−(Order Quantity×MRPC)) and determining whether the credit result is greater than zero.

14. The system of claim 9, wherein the profit and loss data and the margin data are to be computed by and received from a gateway.

15. The system of claim 9, wherein the computing device is to receive from a gateway at least one of a crossing order check result and a position risk check result for the order and the user, the crossing order check result and the position risk check result to be used by the computing device to determine the risk.

16. The system of claim 9, wherein the computed profit and loss data is computed by summing realized profit and loss and unrealized profit and loss over contracts for which the user has at least one fill.

17. The system of claim 9, wherein the computing device comprises a strategy engine.

18. The system of claim 9, wherein the computing device comprises a dedicated risk server.

19. A tangible computer-readable storage medium comprising instructions that, when executed, cause a computing device to at least:
receive an order for a quantity of a tradeable object outbound to an exchange;
receive computed profit and loss data and margin data for a user associated with the order, the profit and loss data and margin data computed external to the computing device;
evaluate whether the quantity associated with the order is greater than an order quantity limit;
compute a credit check with respect to the user and the order based on the profit and loss data and the margin data;
determine a risk associated with the order based on evaluating the quantity of the order and the credit check; and
facilitate routing of the order to the exchange based on the risk.
